(19) United States
(12) Patent Application Publication
(10) Pub. No.: US 2009/0117263 A1
(43) Pub. Date: May 7, 2009

(54) METHOD OF PRODUCING ELECTRODE LAYER FOR FUEL CELL

(75) Inventors: Hideki Kaido, Tochigi (JP); Youhei Kobayashi, Tochigi (JP); Ayumi Mizuno, Tochigi (JP); Keiko Eto, Tochigi (JP); Ichiro Tanaka, Saitama (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/577,845

(22) PCT Filed: Oct. 18, 2005
(86) PCT No.: PCT/JP05/19453

§ 371 Date: Apr. 24, 2007

(30) Foreign Application Priority Data
Nov. 10, 2004 (JP) 2004-326662

(51) Int. Cl. H01M 4/04; B05D 5/12

(52) U.S. Cl. 427/115

(57) ABSTRACT

A method of producing an electrode layer for a fuel cell, with which the electrode layer is produced by heating and drying an electrode paste (41) applied on a sheet-like base material (42). The method includes a process of heating the electrode paste from below the sheet-like base material. Vapor (74) produced above the electrode paste is removed by the heating to produce the electrode layer.

### TECHNICAL FIELD

The present invention relates to a method for producing an electrode layer for a fuel cell, wherein a sheet-form substrate is coated with an electrode paste for an electrode layer and the coated electrode paste is dried to obtain the electrode layer.

### BACKGROUND ART

In a conventional fuel cell 100 shown in FIG. 9 hereof, a cathode electrode 102 and an anode electrode 103 are stacked on either surface of an ion-exchange film 101; a cathode diffusion layer 104 is stacked on the cathode electrode layer 102; an anode diffusion layer 105 is stacked on the anode electrode 103; an oxygen gas flow channel (not shown) is provided to the outside of the cathode diffusion layer 104; and a hydrogen gas flow channel (not shown) is provided to the outside of the anode diffusion layer 105.

Oxygen gas is circulated through the oxygen gas flow channel and hydrogen gas is circulated through the hydrogen gas flow channel, whereby hydrogen (H₂) is brought into contact with a catalyst in the anode electrode 103 and oxygen (O₂) is brought into contact with a catalyst in the cathode electrode 102, and an electric current is generated.

Hydrogen ions (H⁺) generated by a reaction in the anode electrode 103 pass through the ion exchange membrane 101 and flow toward the cathode electrode 102 as indicated by the arrow.

Meanwhile, oxygen gas is fed into the cathode electrode 102 from the oxygen gas flow channel, whereby oxygen gas is circulated into the cathode electrode 102.

Accordingly, the hydrogen ions (H⁺) and oxygen (O₂) react and water (H₂O) is formed as a result. The reaction between the hydrogen ions (H⁺) and oxygen (O₂) progresses particularly in an area 102a indicated by the hatching near an interface 106 with the ion exchange membrane 101.

The present applicants therefore provided, in Japanese Patent Laid-Open Publication No. 2004-47455 (JP 2004-47455 A), a fuel cell having an increased amount of ion exchange resin in the area 102a so that the reaction between the hydrogen ions (H⁺) and oxygen (O₂) would proceed more efficiently in the area 102a.

In the fuel cell according to the 2004-47455 publication, the cathode electrode 102 is divided into a first electrode layer on the surface that is further from the ion exchange membrane 101 and a second electrode layer on the surface that is in contact with the ion exchange membrane 101, and the amount of ion exchange resin in the second electrode layer is increased.

Thus, when the amount of ion exchange resin in the second electrode layer is increased, the adhesion between the cathode electrode 102 and ion exchange membrane 101 is enhanced, and the reaction between the hydrogen ions (H⁺) and oxygen (O₂) progresses more efficiently in the area 102a.

Therefore, the cathode electrode 102 according to the 2004-47455 publication changes the spray pressure when the electrode paste for forming the first and second electrode layers is applied, whereby the amount of ion exchange resin in each of the electrode layers is changed. Specifically, once the electrode paste for the first electrode layer has been applied under a spraying pressure, the electrode paste for the second electrode layer is applied at a higher spraying pressure. The amount of ion exchange resin for the second electrode layer is increased thereby. In other words, the amount of ion exchange resin in each of the electrode layers is changed by altering the spray pressure.

For this reason, the step for applying the first electrode layer and the step for applying the second electrode layer must be performed separately, and time is required for the step for applying the cathode electrode 102. This presents an obstacle to achieving improvements in productivity, and considerable scope exists for improved fuel cell productivity.

### DISCLOSURE OF THE INVENTION

According to the present invention, there is provided a method for producing an electrode layer for a fuel cell, wherein a sheet-form substrate is coated with an electrode paste for an electrode layer, and the coated electrode paste is dried to provide the electrode layer, which method comprises the steps of: coating the sheet-form substrate with the electrode paste; heating the electrode paste from below the sheet-form substrate; and eliminating vapors generated above the electrode paste by the heating, to thereby provide the electrode layer.

Heating the electrode paste from below the sheet-form substrate will cause a solvent on the lower surface in the electrode paste to be heated. The heated solvent will move upward and evaporate from the top surface. Removing the vapor will allow the heated solvent on the lower side to be quickly moved upward. Quickly moving the heated solvent upward will create a small upward-heading vortex in the electrode paste. The small vortex will quickly move the lower ion exchange resin contained in the electrode paste upward along with the solvent. The ion exchange resin in the electrode paste can thereby be concentrated near the top surface before the electrode paste dries.

The electrode layer in which the electrode paste has dried will thereby be formed so that the amount of ion exchange resin gradually increases from the lower surface toward the upper surface. Accordingly, generating the small vortex in the electrode paste will facilitate the formation of an electrode layer in which the ion exchange resin is gradually varied, and will enable the productivity of the fuel cell to be increased.

Preferably, in the method of the present invention, the electrode paste is continually coated on the sheet-form substrate at fixed intervals, and the electrode paste is heated using hot air blown upward from below.

A configuration considered for use as heating means for drying the electrode paste involves bringing the sheet-form substrate into contact with a heating roll, and conveying heat from the heating roll to the electrode paste via the sheet-form substrate, whereby the electrode paste is dried. However, a plurality of heating rolls is necessary in order to dry the electrode paste via heating rolls, which presents an obstacle to simplifying the equipment. Therefore, in the present invention, the electrode paste is heated via hot air. The plurality of heating rollers can thereby be eliminated.

In addition, hot air is blown upward from below, whereby vapor that has evaporated from the electrode paste is directed upward by the hot air. The vapor that has evaporated from the electrode paste can thereby be eliminated from the periphery of the electrode paste. Accordingly, the equipment can be simplified, the solvent in the electrode paste can be moved upward more quickly, and the ion exchange resin in the electrode paste can be more efficiently concentrated near the top surface.

### BRIEF DESCRIPTION OF THE DRAWINGS

FIG. 1 is a perspective view illustrating a fuel cell including an electrode layer according to the present invention, with one cell exploded;

FIG. 2 is a cross-sectional view illustrating on an enlarged scale the electrode layer according to the present invention;

FIG. 3 is a schematic view showing a device for performing the electrode lay producing method according to the present invention;

FIG. 4 is a schematic view showing a part of a heating oven shown in FIG. 3;

FIG. 5 is a schematic view showing an overview of the electrode layer producing method according to the present invention, in which the electrode paste is heated in the heating oven shown in FIG. 4 using hot air;

FIGS. 6A through 6D are schematic views showing examples in which hot air is blown onto the electrode paste and the electrode paste is dried;

FIG. 7 is a schematic view showing a mode of measuring the ratio between the ion-exchange resin and carbon of the electrode layer;

FIG. 8 is a graph showing a comparison between the ratio of the ion-exchange resin and carbon of the electrode layer in standard and comparative examples; and

FIG. 9 is a schematic view showing a cell of a conventional fuel cell.

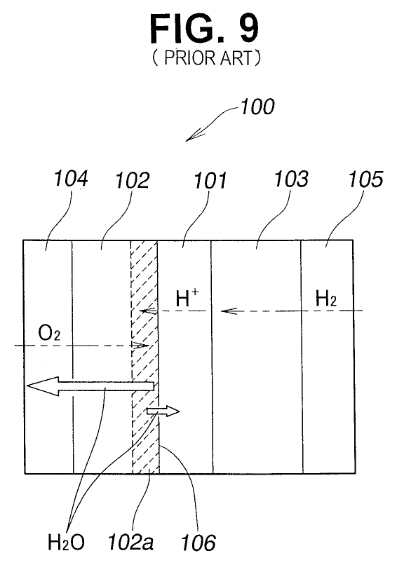

### BEST MODE FOR CARRYING OUT THE INVENTION

An embodiment of the present invention shall be described in detail hereunder with reference to the attached drawings.

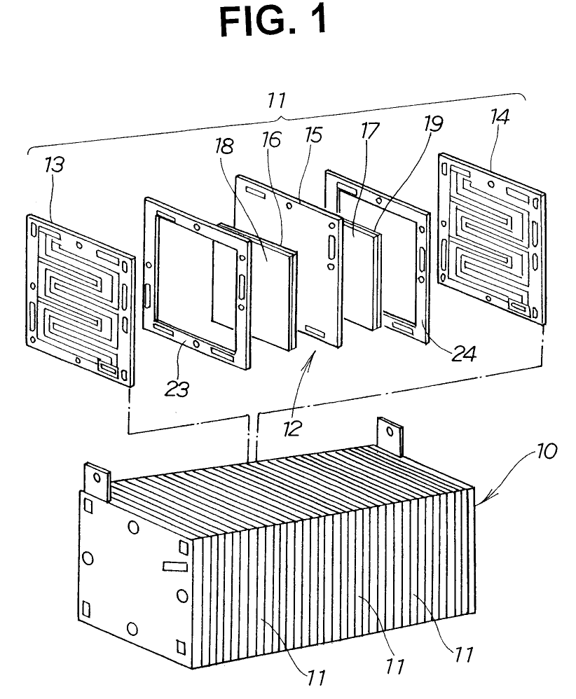

A fuel cell 10 shown in FIG. 1 is composed of a plurality of stacked cells 11. The unit cells 11 comprise separators 13, 14 on either side of a membrane electrode assembly 12.

In the membrane electrode assembly 12, a cathode electrode (oxygen pole) 16 and an anode electrode (fuel pole) 17 are stacked on either surface of an ion exchange membrane 15, a cathode diffusion layer 18 is stacked on the cathode electrode 16, and an anode diffusion layer 19 is stacked on the anode electrode 17. The cathode electrode 16 corresponds to the electrode layer for a fuel cell according to the present invention.

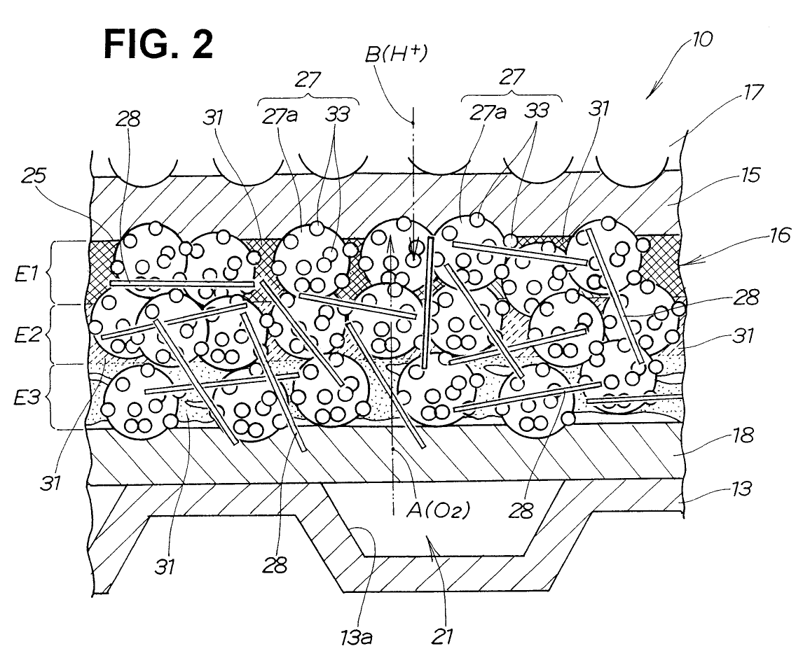

A separator 13 is provided to the outside of the cathode diffusion layer 18, whereby an oxygen gas flow channel 21 (see FIG. 2) is formed by the cathode diffusion layer 18 and the separator 13. A separator 14 is provided to the outside of the anode diffusion layer 19, whereby a hydrogen gas flow channel (not shown) is formed by the anode diffusion layer 19 and the separator 14.

A seal 23 is interposed between the ion exchange membrane 15 and separator 13, whereby the space between the ion exchange membrane 15 and separator 13 is sealed.

A seal 24 is interposed between the ion exchange membrane 15 and separator 14, whereby the space between the ion exchange membrane 15 and separator 14 is sealed.

FIG. 2 shows the electrode layer for a fuel cell in an enlarged state.

The cathode electrode 16 is stacked on one surface of the ion exchange membrane 15, the cathode diffusion layer 18 is stacked on the cathode electrode 16, and the separator 13 is provided to the outside of the cathode diffusion layer 18. The aforementioned oxygen gas flow channel 21 is formed by stacking the separator 13, on which a plurality of grooves 13a is formed, on the outside of the cathode diffusion layer 18.

The cathode electrode 16 has a powdered electrically conductive material 27, a pore-forming agent 28, and an ion exchange resin 31.

The powdered electrically conductive material 27, for example, supports a catalyst composed of platinum (Pt) at the periphery of a carbon powder 27a.

The pore-forming agent 28 is composed of, e.g., electrically conductive acicular carbon fibers. The pore-forming agent 28 alters the porosity of the cathode electrode 16. The porosity increases as the amount of pore-forming agent 28 increases.

Nafion (registered trademark of DuPont) is an example of a material that can be used for the ion exchange resin 31. Increasing the amount of ion exchange resin 31 will lead to improvements in adhesion. An example in which Nafion is used for the ion exchange resin 31 shall be described hereunder.

A large amount of the ion exchange resin 31 is contained in area E1, a medium amount is contained in area E2, and a small amount is contained in area E3. In other words, the ion exchange resin 31 content is distributed so that the density thereof gradually increases from the cathode diffusion layer 18 toward the ion exchange membrane 15.

According to the fuel cell 10, oxygen gas is provided to the oxygen gas flow channel 21, whereby oxygen (02) enters the cathode electrode 16 via the cathode diffusion layer 18 as indicated by the arrow A.

Meanwhile, hydrogen ions (H⁺) generated by the reaction in the anode electrode 17 pass through the ion exchange membrane 15, and approach the cathode electrode 16 in the manner indicated by arrow B.

The hydrogen ions (H⁺) and oxygen (O₂) accordingly react and water is generated as a result. The reaction between the hydrogen ions (H⁺) and oxygen (O₂) proceeds within the cathode electrode 16 in the area E1, and particularly in the area near an interface 25 with the ion exchange membrane 15.

The density of the ion exchange resin 31 is high in the area E1. The cathode electrode 16 is therefore securely affixed to the ion exchange membrane 15. The reaction between the hydrogen ions (H⁺) and oxygen (O₂) is thereby efficiently ensured.

The water generated by the reaction between the hydrogen ions (H⁺) and oxygen (O₂) flows out from the cathode electrode 16 and to the cathode diffusion layer 18.

A device for producing the cathode electrode 16 as an electrode layer for a fuel cell and a method for producing the cathode electrode 16 shall be described hereunder.

The device and method for producing the electrode layer for a fuel cell shall be described with the pore-forming agent 28 having been removed from the cathode electrode 16 in order to facilitate understanding.

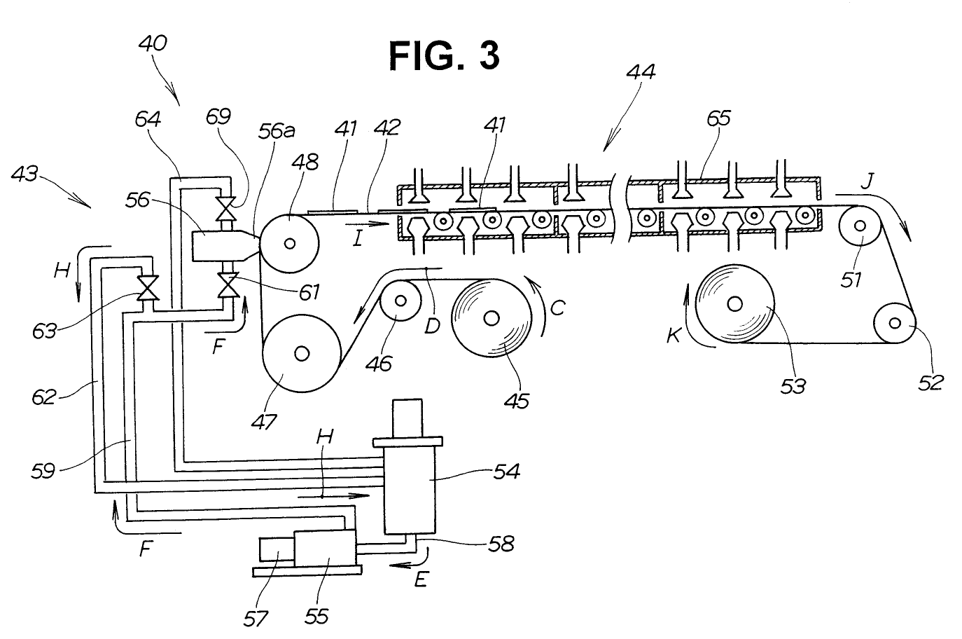

FIG. 3 schematically shows the device for performing the method of producing an electrode layer for a fuel cell according to the present invention.

In FIG. 3, the device for producing an electrode layer for a fuel cell 40 comprises coating means 43 for applying an electrode paste 41 to a long sheet-form substrate 42; a heating oven 44 for drying the electrode paste 41 applied to the sheet-form substrate 42; a carrying roll 45 on the upstream side of the heating oven 44 for carrying the sheet-form substrate 42 that has been wound up into a roll; first and second transfer rolls 46, 47; a coating roll 48; third and fourth transfer rolls 51, 52 disposed on the downstream side of the heating oven 44; and a take-up roll 53 for rolling up the sheet-form substrate 42.

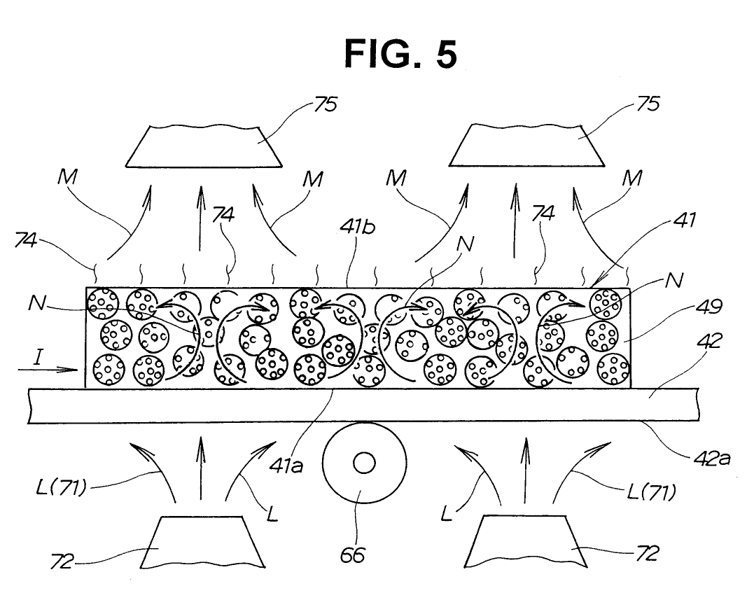

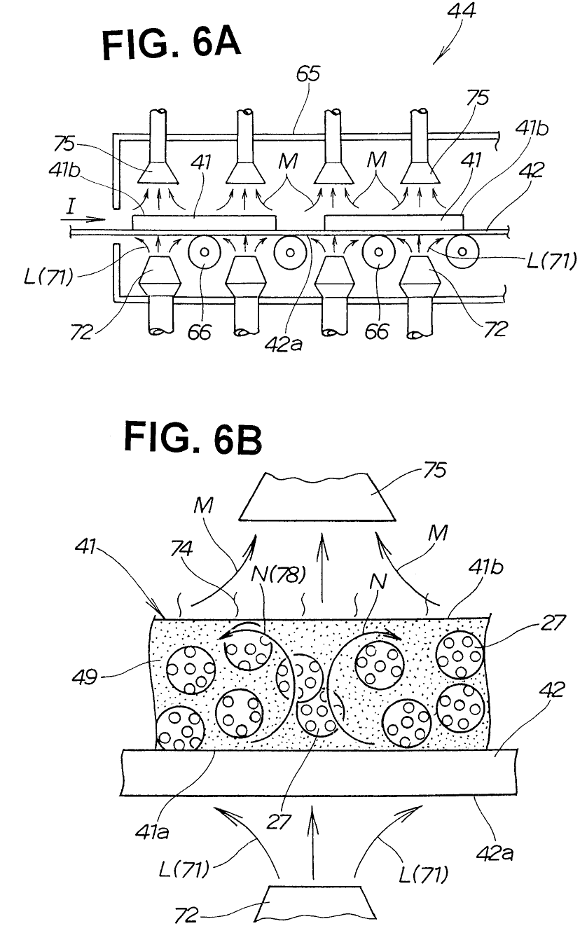

The electrode paste 41 is an electrode in paste form that has a powdered electrically conductive material 27, a pore-forming agent 28 (see FIG. 2), and a solvent 49 (see FIGS. 5 and 6B). The solvent 49 contains Nafion 31 (see FIG. 2).

The coating means 43 comprises a holding tank 54 for holding the electrode paste 41; a pump 55 for discharging the electrode paste 41 from the holding tank 54; and a coating part 56 for applying the discharged electrode paste 41 onto the sheet-form substrate 42.

When a cathode electrode 16 is produced by the production device 40, the carrying roll 45 rotates as indicated by the arrow C, and the sheet-form substrate 42 is carried from the carrying roll 45 as indicated by the arrow D. At the same time, the pump 55 is driven by a motor 57, whereby the electrode paste 41 in the holding tank 54 is suctioned to the pump 55 as indicated by the arrow E via a suction flow channel 58, and the suctioned electrode paste 41 is carried from the pump 55 to a discharge flow channel 59 as indicated by the arrow F.

When a coating valve 61 provided to the discharge flow channel 59 in the vicinity of the coating part 56 is opened and a return valve 63 provided to a first return flow channel 62 in the vicinity of the discharge flow channel 59 is closed, the electrode paste 41 discharged to the discharge flow channel 59 is discharged from an application opening 56a of the discharging part 56 and applied to the surface of the sheet-form substrate 42.

Once a predetermined amount of the electrode paste 41 has been applied to the sheet-form substrate 42, the coating valve 61 is closed and the return valve 63 is closed, whereby the electrode paste 41 discharged to the discharge flow channel 59 passes through the first return flow channel 62 and returns to the holding tank 54 as indicated by the arrow H.

The sheet-form substrate 42 to which the electrode paste 41 has been applied is carried into the heating oven 44 as indicated by the arrow I.

The electrode paste 41 is dried in the heating oven 44 and becomes the cathode electrode 16. The cathode electrode 16 is carried out of the heating oven 44 along with the sheet-form substrate 42 as indicated by the arrow J, and is rolled up by the take-up roll 53 as indicated by the arrow K.

The coating part 56 communicates with an air-removal pipe 64. When the coating part 56 is filled with the electrode paste 41, a valve 69 is opened and air is removed using the air-removal pipe 64. The valve 69 is closed when the electrode 41 is applied to the sheet-form substrate 42.

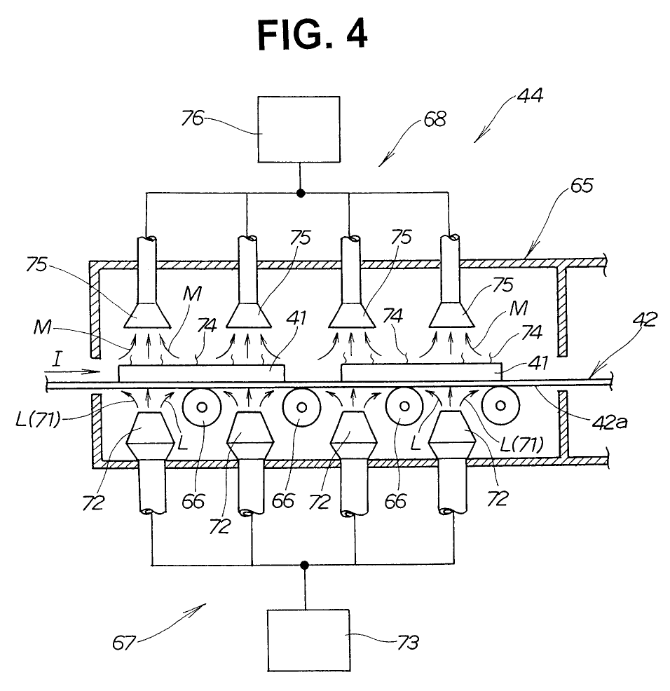

The heating oven 44 shown in FIG. 4 comprises a plurality of delivery rolls 66 for delivering the sheet-form substrate 42 into an oven main body 65, heating means 67 disposed below the delivery rolls 66, and air-intake means 68 disposed above the delivery rolls 66.

The heating means 67 has a hot air supplying part 73 for supplying hot air 71 and a plurality of blowing nozzles 72 that is in communication with the hot air supplying part 73. Each of the blowing nozzles 72 is disposed facing upward between two delivery rolls 66.

The hot air 71 supplied from the hot air supplying part 73 to the blowing nozzles 72 is blown upward from the blowing nozzles 72 as indicated by the arrow L.

The electrode paste 41 is heated by the hot air 71. Therefore, a plurality of heating rolls (not shown) is rendered unnecessary and the device can be simplified.

The air-intake means 68 comprises a suctioning part 76. The suctioning part 76 is in communication with a plurality of suction openings 75. The suction openings 75 are disposed above the electrode paste 41. The suctioning part 76 is driven, and the vapor 74 (see also FIG. 5) produced above the electrode paste 41 is suctioned off as indicated by the arrow M.

The hot air 71 is blown in the upward direction from below via the blowing nozzles 72 of the heating means 67 as indicated by the arrow L, and the blown hot air 71 strikes a lower surface 42a of the sheet-form substrate 42. Heat will be applied to the electrode paste 41 from below the sheet-form substrate 42 by the hot air 71 striking the lower surface 42a of the sheet-form substrate 42.

At the same time, the suctioning part 76 of the air-intake means 68 is driven, whereby the vapor 74 produced above the electrode paste 41 is suctioned from the suction openings 75 as indicated by the arrow M. The vapor 74 produced above the electrode paste 41 is thereby eliminated.

In addition, the hot air 71 is blown in the upward direction from below by the heating means 67, whereby the vapor 74 that has evaporated from the electrode paste 41 is directed upward by the hot air 71. The vapor 74 that has evaporated from the electrode paste 41 can thereby be eliminated from the periphery of the electrode paste 41.

The solvent 49 (see FIG. 5) in the electrode paste 41 can thereby be moved upward more quickly. Therefore, the ion exchange resin (Nafion) 31 (see FIG. 2) in the electrode paste 41 can be concentrated more efficiently in the vicinity of the upper surface of the electrode paste 41.

An overview of the method of producing an electrode film for a fuel cell shall next be described with reference made to FIG. 5.

According to FIG. 5, the electrode paste 41 is delivered along with the sheet-form substrate 42 via the delivering roll 66 as indicated by the arrow I.

In this embodiment, the hot air 71 is blown from the blowing nozzles 72 as indicated by the arrow L. The blown air 71 strikes the lower surface 42a of the sheet-form substrate 42 and heats a lower surface 41a of the electrode paste 41 from below the sheet-form substrate 42.

The portion of the solvent 49 in the electrode paste 41 that is on the lower surface 41a is heated, and the heated solvent 49 moves toward an upper surface 41b.

The heated solvent 49 reaches the upper surface 41b, whereby part of the solvent 49 evaporates from the upper surface 41b as the vapor 74. The remaining portion of the solvent 49 that has reached the top surface 41b comes into contact with external air, cools, and moves downward. An upward vortex is thereby generated by the solvent 49 in the electrode paste 41 as indicated by the arrow N.

The vapor 74 produced above the top surface 41b of the electrode paste 41 is suctioned from the suction openings 75 as indicated by the arrow M. The vapor 74 produced above the top surface 41b is thereby eliminated.

Eliminating the vapor 74 will make it possible for the solvent 49 on the heated lower surface 41a to quickly move toward the top surface 41b. The upward vortex created by the solvent 49 thereby becomes a small vortex.

The method of producing an electrode layer for a fuel cell shall next be described in detail with reference to FIGS. 6A through 6D.

First, as shown in FIG. 6A, the sheet-form substrate 42 is delivered via the delivery rolls 66 in the heating oven 44 as indicated by the arrow I, whereby the electrode paste 41 is carried into the oven main body 65 along with the sheet-form substrate 42 as indicated by the arrow I.

In this embodiment, the hot air 71 blown from the blowing nozzles 72 strikes the lower surface 42a of the sheet-form substrate 42 as indicated by the arrow L. At the same time, vapor generated from the top surface 41b of the electrode paste 41 is suctioned as indicated by the arrow M via the suctioning openings 75 disposed above the electrode paste 41.

Directly after the electrode paste 41 has been carried into the oven main body 65 as described in FIG. 6A, the solvent 49 is uniformly present over the entire area within the electrode paste 41, as shown in FIG. 6B. The powdered electrically conductive material 27 and pore-forming agent 28 (see FIG. 2) are also contained in the electrode paste 41.

In this state, the hot air 71 strikes the lower surface 42a of the sheet-form substrate 42 as indicated by the arrow L, whereby heat is applied to the lower surface 41a of the electrode paste 41 from below the sheet-form substrate 42.

The portion of the solvent 49 in the electrode paste 41 that is on the lower surface 41a is heated, and the heated solvent 49 rises toward the upper surface 41b.

When the heated solvent 49 reaches the upper surface 41b, a portion of the solvent 49 will evaporate from the upper surface 41b as the vapor 74.

The remaining portion of the solvent 49 that has reached the upper surface 41b makes contact with external air, cools, and moves downward. An upward vortex is thereby generated by the solvent 49 in the electrode paste 41 as indicated by the arrow N.

The vapor 74 produced above the upper surface 41b is suctioned from the suctioning openings 75 as indicated by the arrow M, whereby the vapor 74 produced above the electrode paste 41 is eliminated. The heated solvent 4 on the lower side can thereby be quickly moved upward. Therefore, the upward vortex created by the solvent 49 becomes a small vortex 78.

In FIG. 6C, the ion exchange resin; i.e., Nafion 31 (see FIG. 2) contained in the solvent 49 is quickly moved upward by the resulting small vortex 78.

The Nafion 31 is thereby concentrated in an area e1 at the upper surface 41b in the electrode paste 41. The area e1 in which the Nafion 31 is concentrated is indicated by hatching.

Concentration of the Nafion 31 in the area e1 will lead to a decrease in the amount of Nafion 31 in an area e2 at the lower surface side 41a of the electrode paste 41.

In FIG. 6D, when the electrode paste 41 is heated by the hot air 71, the vapor 74 continues to be removed, whereby the Nafion 31 is further concentrated at the upper surface 41b in the electrode paste 41, and a high-density area E1 is thereby formed.

The Nafion 31 is somewhat concentrated in the middle region within the electrode paste 41, which accordingly becomes a medium-density area E2.

The Nafion 31 is concentrated in the area E1 and middle area E2. A low-density area E3 accordingly forms at the lower surface 41a where little Nafion 31 is present.

On the other hand, substantially no solvent 49 is present in the areas E1, E2. Therefore, the solvent 49 is concentrated in the vicinity of the cathode diffusion layer 18 of the area E3. In this state, the solvent 49 in the electrode paste 41 is dried to yield the cathode electrode 16 shown in FIG. 2.

As described above, an upward small vortex 78 is generated within the electrode paste 41, whereby an ion exchange resin contained in the electrode paste 41 on the lower side is quickly moved upward along with the solvent. The Nafion 31 in the electrode paste 41 is thereby concentrated in the vicinity of the upper surface 41b before the electrode paste 41 dries.

The coating part 56 shown in FIG. 3 is preferably placed adjacent to the heating oven 44 because the Nafion 31 in the electrode paste 41 is concentrated in the vicinity of the upper surface 41b before the electrode paste 41 dries and the amount of Nafion 31 present at the lower surface 41a is reduced. As a result, the electrode paste 41 can be quickly dried by the hot air 71 once the electrode paste 41 has been applied by the coating part 56 to the sheet-form substrate 42. Therefore, the Nafion 31 in the electrode paste 41 will be concentrated in the vicinity of the upper surface 41b before the electrode paste 41 dries, and the amount of the Nafion 31 at the lower surface 41a will be more reliably reduced.

The resulting cathode electrode 16 is stacked between the ion exchange membrane 15 and cathode diffusion layer 18, and the resulting material is then peeled from the sheet-form substrate 42 and used.

In the cathode electrode 16, a large amount of the Nafion 31 is contained in the area E1, a medium amount is contained in the area E2, and a small amount is contained in the area E3, as shown in FIG. 2. In other words, in the cathode electrode 16, the Nafion 31 content is distributed so that the density thereof gradually increases from the cathode diffusion layer 18 toward the ion exchange membrane 15.

As described in FIGS. 6A through 6D, according to the method of producing an electrode layer for a fuel cell, a small eddy 78 is generated in the electrode paste 41, whereby the Nation 31 is added before the solvent 49 dries so that the density gradually increases from the cathode diffusion layer 18 toward the ion exchange membrane 15. A cathode electrode 16 in which the Nafion 31 is gradually varied can thereby be produced in a straightforward manner.

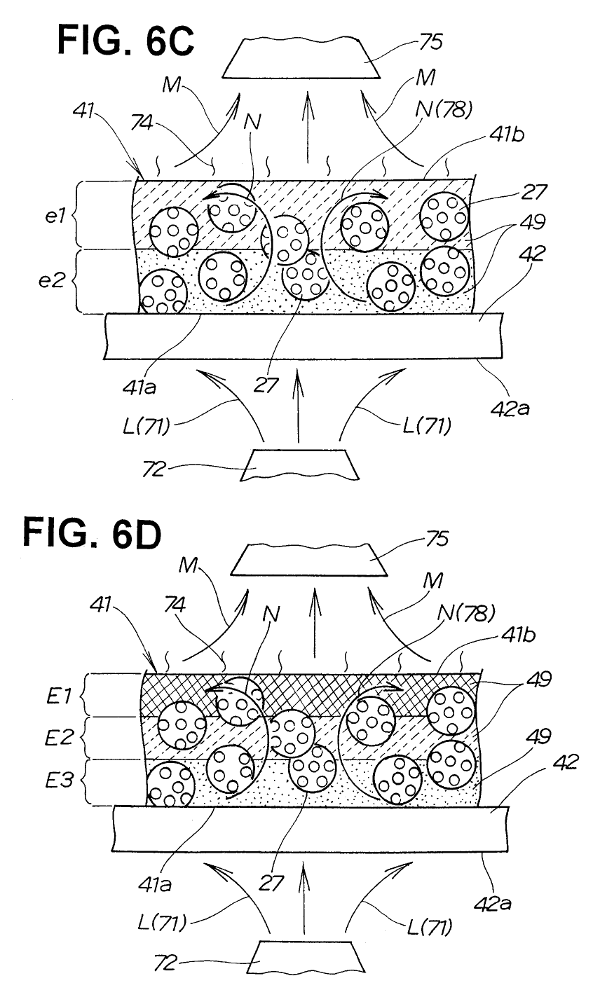

FIG. 7 shows a schematic view for measuring the ratio between the ion exchange resin and carbon in the electrode layer for a fuel cell.

In FIG. 7, within the cathode electrode 16, an interface 25 with the ion exchange membrane 15 (see FIG. 2) is an ion exchange membrane interface, and an interface 26 with the cathode diffusion layer 18 (see FIG. 2) is a diffusion layer interface.

The ion exchange resin/carbon ratio at the ion exchange membrane interface 25 is a first ion exchange resin/carbon ratio, and the ion exchange resin/carbon ratio at the diffusion layer interface 26 is a second ion exchange resin/carbon ratio.

First, a method for obtaining the first ion exchange resin/carbon ratio at the ion exchange membrane interface 25 shall be described.

X-rays of a fixed wavelength are emitted onto the ion exchange membrane interface 25 of the cathode electrode 16 as indicated by the arrow P, and secondary X-rays are generated from the ion exchange membrane interface 25 as indicated by the arrow Q.

The spectrum of the secondary X-rays is measured using a dispersive crystal (not shown), and the ratio of the ion exchange resin (Nafion) and carbon (C) at the ion exchange membrane interface 25 is analyzed.

Specifically, the amount S contained in the Nafion 31 and the amount of catalyst (Pt) 33 (see FIG. 2) supported on the powdered carbon 27a (see FIG. 2) are measured.

The ratio of Nafion and carbon at the ion exchange membrane interface 25, i.e., the first ion exchange resin/carbon ratio, is obtained on the basis of the amounts S and Pt that have been measured.

The amount S is the amount of elemental sulfur in the sulfonic acid group in the ion exchange resin.

A method for determining the second ion exchange resin/carbon ratio at the diffusion layer interface 26 shall next be described.

As with the method for determining the first ion exchange resin/carbon ratio, X-rays of a fixed wavelength are emitted onto the diffusion layer interface 26 of the cathode electrode 16, and secondary X-rays generated from the diffusion layer interface 26 are measured using a dispersive crystal.

The ratio of the ion exchange resin (Nafion) and carbon (C) at the diffusion layer interface 26 is analyzed on the basis of the measured values, and the second ion exchange resin/carbon ratio is determined.

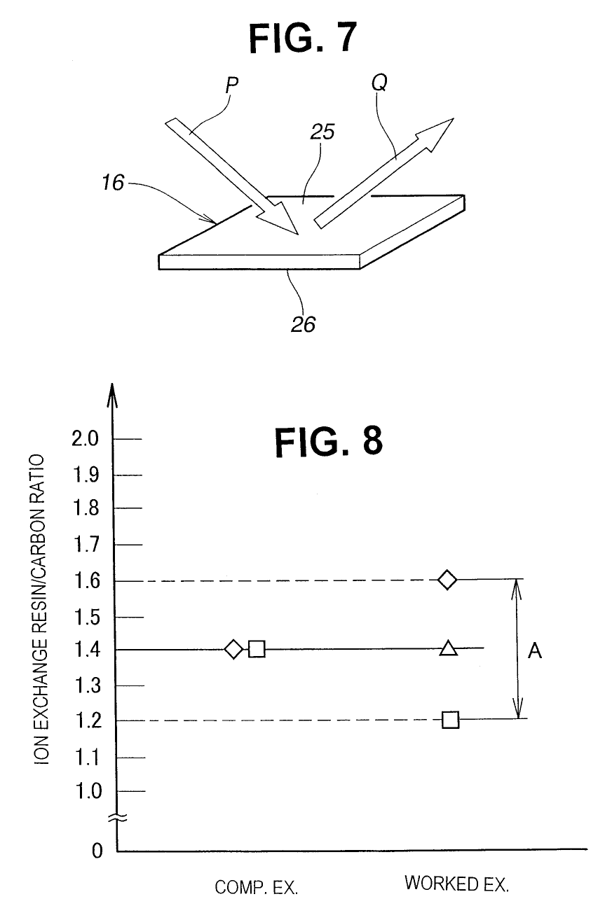

FIG. 8 is a graph showing the ratio of the ion exchange resin and carbon in the electrode layer for a fuel cell. The vertical axis indicates the ion exchange resin/carbon ratio, and the horizontal axis indicates standard and comparative examples.

In the comparative example, the coating means 43 is used to apply the electrode paste 41 on the sheet-form substrate 42 shown in FIG. 3, whereupon the electrode paste 41 is dried via a normal drying method to yield a cathode electrode (not shown).

The working example is a cathode electrode 16 produced via the method of producing an electrode layer for a fuel cell shown in FIGS. 6 and 7.

In the cathode electrode of the comparative example, the first ion exchange resin/carbon ratio at the ion exchange membrane interface is 1.4, as indicated by the ⋄ symbol; and the second ion exchange resin/carbon ratio at the diffusion layer interface is 1.4, as indicated by the □ symbol. In other words, the first and second ion exchange resin/carbon ratios in the cathode electrode of the comparative example have the same value. It is accordingly evident that, in the cathode electrode of the comparative example, the amount of ion exchange resin (Nafion) at the ion exchange membrane interface and the amount of ion exchange resin (Nafion) at the diffusion layer interface 26 are the same.

On the other hand, in the cathode electrode 16 of the working example, the first ion exchange resin/carbon ratio at the ion exchange membrane interface 25 is 1.6, as indicated by the ⋄ symbol; the second ion exchange resin/carbon ratio at the diffusion layer interface 26 is 1.2, as indicated by the □ symbol; and the average value of the first ion exchange resin/carbon ratio 1.6 and the second ion exchange resin/carbon ratio 1.2 is 1.4, as indicated by the Δ symbol. The average value 1.4 is the same as the first and second ion exchange resin/carbon ratios of the cathode electrode of the comparative example.

It is accordingly evident that, in the cathode electrode 16 of the working example, the amount of ion exchange resin (Nafion) at the ion exchange membrane interface 25 has increased, and the amount of ion exchange resin (Nafion) at the diffusion layer interface 26 has decreased. In other words, it is apparent that, in the cathode electrode 16 of the working example, the amount of ion exchange resin (Nafion) gradually increases from the diffusion layer interface 26 toward the ion exchange membrane interface 25.

Thus, the increase in regard to the amount of the ion exchange resin (Nafion) at the ion exchange membrane interface 25 in the cathode electrode 16 of the working example makes it possible to improve the adhesion to the ion exchange membrane at the ion exchange membrane interface 25. The efficiency of the reaction in the vicinity of the ion exchange membrane interface 25 in the cathode electrode 16 can thereby be increased.

The ion exchange resin/carbon ratio difference A between the first ion exchange resin/carbon ratio of 1.6 and the second ion exchange resin/carbon ratio of 1.4 is 0.4, which is 0.2 or greater.

An ion exchange resin/carbon ratio difference A of 0.2 or greater will allow the adhesion between the cathode 16 and ion exchange membrane 15 to be improved.

In addition, an ion exchange resin/carbon ratio difference A of 0.2 or greater will allow drainage of the water generated in the cathode electrode 16 to be improved.

Problems are thought to occur if the ion exchange resin/carbon ratio difference A exceeds 0.6, insofar as the resistance will increase.

Therefore, the ion exchange resin/carbon ratio difference A is preferably set within a range of 0.2 to 0.6.

In the above-described example, the cathode electrode 16 was described as an example of an electrode layer. However, the electrode layer is not limited thereto, and can also be the anode electrode 17.

### INDUSTRIAL APPLICABILITY

The present invention is useful in producing an electrode layer for a fuel cell wherein an electrode paste for an electrode layer is coated on a sheet-form substrate, and the coated electrode paste is dried to produce an electrode layer.

1. A method for producing an electrode layer for a fuel cell, wherein a sheet-form substrate is coated with an electrode paste for an electrode layer, and the coated electrode paste is dried to obtain the electrode layer, the method comprising the steps of:
coating the sheet-form substrate with the electrode paste for an electrode layer;
heating the electrode paste from below the sheet-form substrate; and
eliminating vapors generated above the electrode paste by the heating, to thereby provide the electrode layer.

2. The method of claim 1, wherein the coating step comprises continuously coating the sheet-form substrate with the electrode paste at fixed intervals, and the heating step is performed using hot air blown upward from below.
